(19) United States
(12) Patent Application Publication
(10) Pub. No.: US 2018/0225612 A1
(43) Pub. Date: Aug. 9, 2018

(54) SYSTEMS AND METHODS FOR ALLOCATING PRODUCT INVENTORY AT GEOGRAPHICALLY DISTRIBUTED LOCATIONS

(71) Applicant: Wal-Mart Stores, Inc., Bentonville, AR (US)

(72) Inventors: Benjamin D. Enssle, Bella Vista, AR (US); Cristy C. Brooks, Cassville, MO (US); David B. Brightwell, Bella Vista, AR (US); David C. Winkle, Bella Vista, AR (US); Greg A. Bryan, Centerton, AR (US); Todd D. Mattingly, Bentonville, AR (US)

(21) Appl. No.: 15/882,853

(22) Filed: Jan. 29, 2018

Related U.S. Application Data
(60) Provisional application No. 62/455,113, filed on Feb. 6, 2017.

(51) Int. Cl. G06Q 10/06; G06Q 10/08; G06Q 30/06

(52) U.S. Cl. CPC G06Q 10/06315; G06Q 10/08355; G06Q 30/0635; G06Q 10/087

(57) ABSTRACT

In some embodiments, methods and systems are provided for facilitating distribution of products between product manufacturers and retail stores of a retailer via specialty distribution centers and regional distribution centers. Based on analysis of various inventory management factors, the products are allocated between different facilities of the retailer to optimize the cost-effectiveness and efficiency of such facilities, and product shipments to and from such facilities are coordinated according to the optimization determination.

### CROSS-REFERENCE TO RELATED APPLICATIONS

This application claims the benefit of U.S. Provisional Application No. 62/455,113, filed Feb. 6, 2017, which is incorporated herein by reference in its entirety.

### TECHNICAL FIELD

This invention relates generally to product inventory allocation and, in particular, to allocating products between distribution centers retail stores of a retailer.

### BACKGROUND

Customers often purchase products from retailers over the internet and retail stores often replenish their product inventory from warehouse facilities. Typically, manufacturers and/or product suppliers transport trucks to a retailer's warehouse facility in order to fulfill product replenishment request(s) generated at retail facilities of the retailer. The trucks are often sent by the product manufacturers/suppliers specifically for the purpose of fulfilling the replenishment requests, such that the trucks are often not full and do not utilize their full product transportation capacity. In addition, products are often shipped to the warehouse facility in pallets having large quantities of product for the purpose of fulfilling the replenishment needs of multiple retail stores, and often require the pallets and/or cases to be broken up and repackaged into smaller quantities at the warehouse facilities to fit the replenishment needs of specific retail stores. Such inefficiencies can add up, lowering profit margins for the retailers.

### BRIEF DESCRIPTION OF THE DRAWINGS

Disclosed herein are embodiments of systems, apparatuses, methods, and systems pertaining to facilitating distribution of products between product manufacturers and retail stores of a retailer via specialty distribution centers and regional distribution centers. This description includes drawings, wherein:

FIG. 1 is a diagram of a system of for facilitating distribution of products between product manufacturers and retail stores of a retailer via specialty distribution centers and regional distribution centers in accordance with some embodiments;

FIG. 2 is a functional diagram of an exemplary computing device usable with the system of FIG. 1 in accordance with some embodiments; and

FIG. 3 is a flow chart diagram of for facilitating distribution of products between product manufacturers and retail stores of a retailer via specialty distribution centers and regional distribution centers in accordance with some embodiments.

Elements in the figures are illustrated for simplicity and clarity and have not been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

The following description is not to be taken in a limiting sense, but is made merely for the purpose of describing the general principles of exemplary embodiments. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Generally speaking, pursuant to various embodiments, systems and methods are provided for facilitating distribution of products between product manufacturers and retail stores of a retailer via specialty distribution centers and regional distribution centers. Based on analysis of various inventory management factors, the systems and methods provided herein allocate the stocks of products between different facilities of the retailer to optimize the cost-effectiveness and efficiency of such facilities, and coordinate product shipments to and from such facilities according to the optimization determination.

In some embodiments, a system for facilitating distribution of products between product manufacturers and retail stores of a retailer via specialty distribution centers and regional distribution centers of the retailer includes an electronic database. The electronic database stores inventory management data that includes: data indicating on-hand inventory at each of the retail stores, each of the specialty distribution centers and each of the regional distribution centers; data indicating replenishment requests and pending orders being fulfilled by the retailer and a total number of the products in transit; and data indicating a total quantity of products in a product shipment being shipped from a manufacturer facility to a specialty distribution center or to a regional distribution center. The system further includes a central computing device including a control circuit having a programmable processor, the central computing device being in communication over a network with a computing device at the manufacturer facility and with the electronic database. The control circuit is configured to: obtain the inventory management data from the electronic database; analyze, based on the inventory management data obtained from the electronic database, the total quantity of products in the product shipment being shipped from the manufacturer facility to the specialty distribution center or to the regional distribution center in order in order to determine whether the total quantity of products in the product shipment supports the product shipment being routed from the manufacturer facility directly to the specialty distribution center or directly to the regional distribution center; upon a determination that the quantity of products in the product shipment supports the product shipment being routed from the manufacturer facility directly to the specialty distribution center, transmit a signal from the central computing device over the network to the computing device of the manufacturer, the signal including instructions to route the product shipment from the manufacturer facility directly to the specialty distribution center; and upon a determination that the quantity of products in the product shipment supports the product shipment being routed from the manufacturer facility directly to the regional distribution center, transmit a signal from the central computing device over the network to the computing device of the manufacturer, the signal including instructions to route the product shipment from the manufacturer facility directly to the regional distribution center.

In some embodiments, a method for facilitating distribution of products between product manufacturers and retail stores of a retailer via specialty distribution centers and regional distribution centers of the retailer includes: providing an electronic database storing inventory management data including: data indicating on-hand inventory at each of the retail stores, each of the specialty distribution centers and each of the regional distribution centers; data indicating replenishment requests and pending orders being fulfilled by the retailer and a total number of the products in transit; and data indicating a total quantity of products in a product shipment being shipped from a manufacturer facility to a specialty distribution center or to a regional distribution center; providing a central computing device including a control circuit having a programmable processor, the central computing device being in communication over a network with a computing device at the manufacturer facility and with the electronic database, the control circuit being configured to: obtain the inventory management data from the electronic database; analyze, based on the inventory management data obtained from the electronic database, the total quantity of products in the product shipment being shipped from the manufacturer facility to the specialty distribution center or to the regional distribution center in order in order to determine whether the total quantity of products in the product shipment supports the product shipment being routed from the manufacturer facility directly to the specialty distribution center or directly to the regional distribution center; upon a determination that the quantity of products in the product shipment supports the product shipment being routed from the manufacturer facility directly to the specialty distribution center, transmit a signal from the central computing device over the network to the computing device of the manufacturer, the signal including instructions to route the product shipment from the manufacturer facility directly to the specialty distribution center; and upon a determination that the quantity of products in the product shipment supports the product shipment being routed from the manufacturer facility directly to the regional distribution center, transmit a signal from the central computing device computer over the network to the computing device of the manufacturer, the signal including instructions to route the product shipment from the manufacturer facility directly to the regional distribution center.

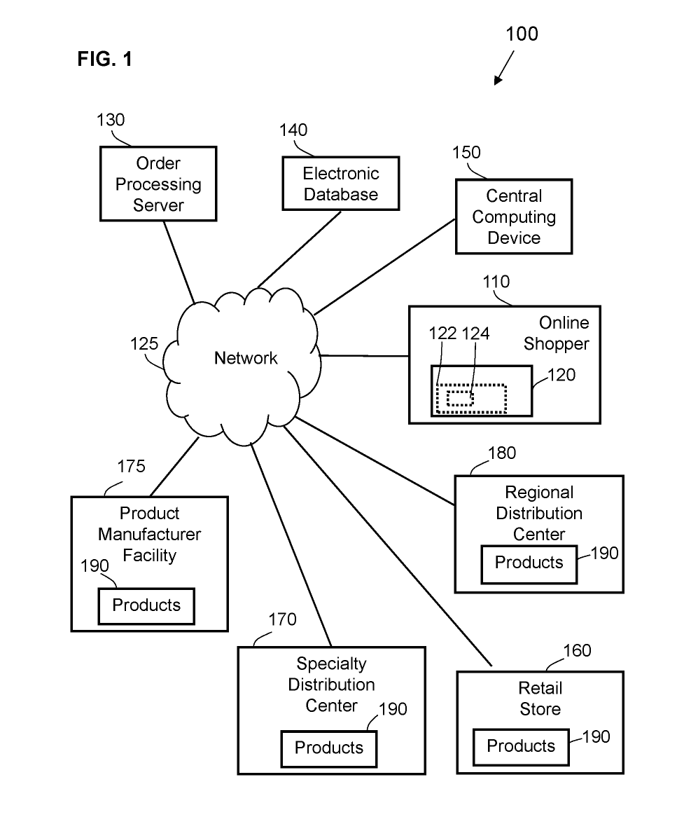

FIG. 1 shows an embodiment of a system 100 for facilitating distribution of products 190 between a product manufacturer/supplier facilities 175 and retail stores 160 of a retailer via specialty distribution centers 170 and a regional distribution centers 180 of the retailer. Generally, product manufacturers/suppliers ship economic order quantities of products 190 to specialty distribution centers 170 and/or regional distribution centers 180, in some aspects, based on tier pricing (i.e., larger discounts per unit of a product 190 for larger number of units of products 190 in an order). In some aspects, a specialty distribution center 170 is a facility that is larger in size than the regional distribution center 180 and is adapted to receive (e.g., via delivery trucks) the products 190 from the manufacturer facility 175 only on pallets and to unpack the products 190 from the pallets, while the regional distribution center 180 is smaller in size than the specialty distribution center 170 and is adapted to receive (e.g., via delivery trucks) the products 190 from the manufacturer facility 175 or the specialty distribution center 170 on pallets, in layers, in cases, or as eaches (i.e., individual products).

The exemplary system 100 depicted in FIG. 1 includes an order processing server 130 configured to process an order for one or more products 190 placed by a customer such as an online shopper 110. In addition, in some embodiments, the order processing server 130 processes orders between the facilities of the retailer and/or the manufacturer, such as replenishment requests for products 190, which can be sent from the retail store 160 and/or specialty distribution center 170 and/or regional distribution center 180 to the manufacturer facility 175, as well as from the retail store 160 to the specialty distribution center 170 and/or regional distribution center 180. For example, in some aspects, the order processing server 130 is configured to transmit, over the network 125, a product fulfillment request to the central computing device 150 based on an order placed by the online shopper 110 and processed by the order processing server 130, such that the central computing device 150, after receipt of the product fulfillment request from the order processing server 130, obtains the inventory management data from the electronic database 140, and analyzes the obtained inventory management data in order to determine whether the product(s) 190 ordered by the online shopper 110 is/are to be delivered to the customer from the retail store 160, specialty distribution center 170, or regional distribution center 180.

The retailer may be any entity operating as a brick-and-mortar physical location and/or a website accessible, for example, via the internet or another network, by way of which products 190 may be ordered by a customer. A customer may be an individual (e.g., online shopper 110) or a business entity. In other words, to the extent that the retail store 160, specialty distribution center 170, and regional distribution center 180 transmit fulfillment requests (i.e., “order”) for products 190 within the system 100 over the network 125, the retail store 160, specialty distribution center 170, and regional distribution center 180 can also be the customers of the product manufacturer facility 175 as well as each other's customers. Exemplary products 190 that may be ordered by customers via the system 100 may include, but are not limited to, general-purpose consumer goods, as well as consumable products, such as medications, food items, and dietary supplements.

Generally, when an online shopper 110 initially sets up an online account with the retailer, for example, using a consumer computing device 120, the system 100 (i.e., order processing server 130 or another server dedicated to new customer sign-up) is configured to permit the online shopper 110 to generate a profile including information associated with the online shopper 110 (e.g., name, address, phone number, and the like), payment methods (e.g., credit card, deposit account, or other payment information), and product delivery settings of the online shopper 110. The online shopper 110 may select new options and/or update previously selected options at any time after setting up the account with the retailer. In some embodiments, the information of the online shopper 110 and any product delivery-related options selected by the online shopper 110 are stored in the electronic database 140 for subsequent retrieval by the order processing server 130 and/or by a central computing device 150 (e.g., in response to a login request or product order placement by the customer).

In some embodiments, as the online shopper 110 is connecting to the system 100 (e.g., via a login interface) using the consumer computing device 120, the order processing server 130 may request a verification of the identity (e.g., username/password) of the online shopper 110. The order processing server 130 may first verify the identity of the online shopper 110, for example, by comparing the username/password data entered by the online shopper 110 into the login interface against username/password data in the profile of the online shopper 110 stored in the electronic database 140. The order processing server 130 may then associate the customer profile with the identity of the online shopper 110, retrieve the customer profile from the electronic database 140 based on information stored in the profile, and send the retrieved customer account information to the consumer computing device 120, which includes a graphical interface 122 (described in more detail below) that permits the online shopper 110 to customize various options relating to the ordering of products 190 from the retailer and/or relating to delivery options for the products 190 to the online shopper 110.

The online shopper 110 may access the order processing server 130 of the retailer via a consumer computing device 120, which may be a stationary, portable, and/or hand-held electronic device, for example, a desktop computer, a laptop computer, a tablet, a mobile phone, or any other electronic, processor-based device that may be configured for data entry and communication with the order processing server 130. In some embodiments, the online shopper 110 may access the order processing server 130 of the retailer via a graphical interface 122 displayed to the online shopper 110 on the consumer computing device 120. The graphical interface 122 may include one or more graphical input fields 124 in the form of menu options and/or sub-interfaces that permit the online shopper 110 to order one or more products 190 and/or select a delivery location for one or more products 190 ordered by the online shopper 110. In some embodiments, the graphical interface 122 may be a retailer-associated mobile application (app) installed on the consumer computing device 120 and configured to display various above-described menu options, notifications, and/or alerts for the online shopper 110. For example, electronic alerts may be transmitted to the consumer computing device 120 from the central computing device 150 and/or from the order processing server 130 and displayed on the consumer computing device 120 via the graphical interface 122.

In some aspects, the order processing server 130 is configured to receive and process an order by the online shopper 110 for a product 190 transmitted from the consumer computing device 120, to receive and process payment for the product 190 from the online shopper 110, and to transmit the processed order via the network 125 to the central computing device 150, which is configured for communication with the order processing server 130 and electronic database 140 via the network 125. It will be appreciated that while the order processing server 130 and the central computing device 150 may be located at separate physical locations (e.g., regional data center, central data center, or the like), the system 100, in some embodiments, may be confined to a single facility of the retailer.

In the embodiment of FIG. 1, the system 100 includes an electronic database 140. In some embodiments, the electronic database 140 is configured to store inventory management data. The electronic database 140 may be stored, for example, on non-volatile storage media (e.g., a hard drive, flash drive, or removable optical disk) internal or external to a computing device. It will be appreciated that the electronic database 140 may likewise be cloud-based.

Inventory management data can include but is not limited to data indicating: (1) on-hand inventory at each of the retail stores 160, specialty distribution centers 170, and regional distribution centers 180; (2) storage capacity of shelves of retail store 160; (3) actual customer demand data (e.g., number of units of product 190 sold at the retail store 160 within a predetermined interval of time); (4) replenishment requests and pending orders being fulfilled by the retailer and a total number of the products 190 in transit; (5) a total quantity of products 190 in a product shipment being shipped from a manufacturer facility 175 to a specialty distribution center 170 or regional distribution center 180; (6) cost to pick-n-pack (pick products 190 off truck and repackage individual products 190 for shipping) vs. case pick (i.e., gather full cartons or boxes of product 190); (7) shipping efficiencies; (8) inbound freight cost (i.e., freight factor); (9) cost per unit of product 190; (10) cost of handling the products 190 at a given specialty distribution center 170 and/or regional distribution center 180; (11), landed cost (i.e., total price of a product 190 when it arrives); (12) carrying cost (i.e., total cost of warehousing inventory); (13) reverse logistics; (14) geographic locations of the manufacturer facility 175, retail store 160, specialty distribution center 170, and regional distribution center 180; (15) product supply availability; (16) time supply of order quantity; (17) profit margin per unit of product 190; (18) merchandising hierarchy (i.e., rules for organization and display of products 190); (19) thresholds (e.g., department, category, or the like); (20) actual customer demand data (e.g., number of units of product 190 sold at the retail store 160 within a predetermined interval of time); and (21) customer demand forecast data (e.g., number of units of product 190 projected to be sold at the retail store 160 within a predetermined interval of time). In some embodiments, as will be discussed in more detail below, the central computing device 150 of the system 100 is configured to analyze one or more factors of the aforementioned inventory management data, and to optimize the organization of shipments to, as well as the allocation of products 190 between, the retail store 160, specialty distribution center 170, and regional distribution center 180.

The central computing device 150 may be a stationary or portable electronic device, for example, a desktop computer, a laptop computer, a tablet, a mobile phone, or any other electronic device including a processor-based control circuit (i.e., control unit). In the embodiment of FIG. 1, the central computing device 150 is configured for data entry and processing (e.g., analysis of inventory management data) as well as for communication with other devices of system 100 via the network 125 which, as described above, may be a wide-area network (WAN), a local area network (LAN), a personal area network (PAN), a wireless local area network (WLAN), or any other internet or intranet network, or combinations of such networks.

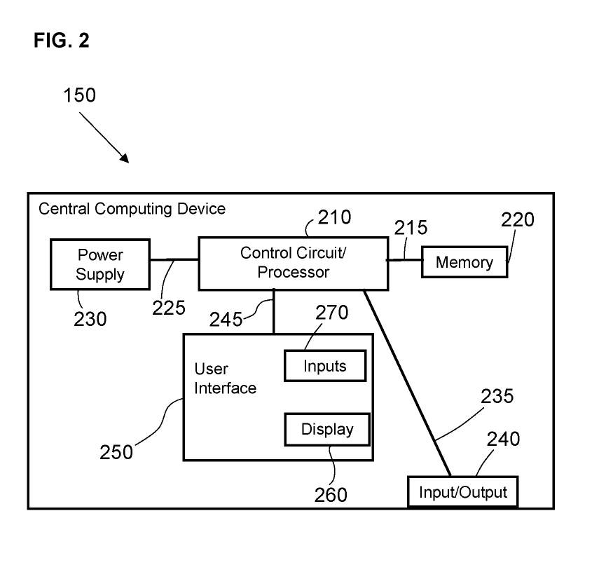

With reference to FIG. 2, an exemplary central computing device 150 configured for use with exemplary systems and methods described herein may include a control circuit or control unit 210 including a processor (for example, a microprocessor or a microcontroller) electrically coupled via a connection 215 to a memory 220 and via a connection 225 to a power supply 230. The control unit 210 can comprise a fixed-purpose hard-wired platform or can comprise a partially or wholly programmable platform, such as a microcontroller, an application specification integrated circuit, a field programmable gate array, and so on. These architectural options are well known and understood in the art and require no further description here.

This control unit 210 can be configured (for example, by using corresponding programming stored in the memory 220 as will be well understood by those skilled in the art) to carry out one or more of the steps, actions, and/or functions described herein. In some embodiments, the memory 220 may be integral to the processor-based control unit 210 or can be physically discrete (in whole or in part) from the control unit 210 and is configured non-transitorily store the computer instructions that, when executed by the control unit 210, cause the control unit 210 to behave as described herein. (As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM)) as well as volatile memory (such as an erasable programmable read-only memory (EPROM))). Accordingly, the memory and/or the control unit may be referred to as a non-transitory medium or non-transitory computer readable medium.

In the embodiment shown in FIG. 2, the control unit 210 of the central computing device 150 is also electrically coupled via a connection 235 to an input/output 240 that can receive signals from the order processing server 130 (e.g., data from the electronic database 140 relating to a product order placed by the customer) or from any other source (e.g., computing device at the product manufacturer facility 175, retail store 160, specialty distribution center 170, and/or regional distribution center 180, consumer computing device 120, or the like) that can communicate with the central computing device 150 via a wired or wireless connection. For example, in some embodiments, the central computing device 150 is configured to receive product replenishment requests over the network 125 from a computing device of the retail store 160, specialty distribution center 170, and/or regional distribution center 180. In some aspects, the control circuit 210 of the central computing device 150 is programmed such that, based on the inventory management data obtained from the electronic database 140, the control circuit 210 determines an optimal shipping destination (e.g., specialty distribution center 170 or regional distribution center 180) for products 190 being shipped from the manufacturer facility 175, as well as determine an optimal shipping source (e.g., retail store 160, specialty distribution center 170, regional distribution center 180) from which products 190 ordered by a online shopper 110 can be delivered to a online shopper 110 (or from which product replenishment requests by the retail store 160 and/or specialty distribution center 170 and/or regional distribution center 180) can be fulfilled. The input/output 240 of the central computing device 150 can also send signals to the order processing server 130, or to any other electronic device in wired or wireless communication with the central computing device 150.

In the embodiment shown in FIG. 2, the processor-based control unit 210 of the central computing device 150 is electrically coupled via a connection 245 to a user interface 250, which may include a visual display or display screen 260 (e.g., LED screen) and/or button input 270 that provide the user interface 250 with the ability to permit an operator of the central computing device 150 to manually control the central computing device 150 by inputting commands via touch-screen and/or button operation and/or voice commands to, for example, to select a retail store 160, specialty distribution center 170, or regional distribution center 180 to which products 190 are to be transported from the manufacturer facility 175 and/or select a retail store 160, specialty distribution center 170, or regional distribution center 180 from which products 190 are to be transported to an online shopper 110. It will be appreciated that the performance of such functions by the processor-based control unit 210 of the central computing device 150 is not dependent on a human operator, and that the control unit 210 may be programmed to perform such functions without a human operator.

In some embodiments, the display screen 260 of central computing device 150 is configured to display various graphical interface-based menus, options, and/or alerts that may be transmitted to the central computing device 150 and displayed on the display screen 260 in connection with various aspects of the order placed by an online shopper 110. The inputs 270 of the central computing device 150 may be configured to permit an operator to navigate through the on-screen menus on the central computing device 150 and select a retail store 160, specialty distribution center 170, or regional distribution center 180 to which the products 190 are to be transported. It will be appreciated that the display screen 260 may be configured as both a display screen and an input 270 (e.g., a touch-screen that permits an operator to press on the display screen 260 to enter text and/or execute commands.)

In some embodiments, the control circuit 210 of the central computing device 150 is programmed to generate and transmit an electronic notification (e.g., alert) in connection with determination of a facility (e.g., retail store 160, specialty distribution center 170, or regional distribution center 180) to which products 190 are to be shipped from a product manufacturer facility 175 and/or in connection with determination of a facility (e.g., retail store 160, specialty distribution center 170, or regional distribution center 180) from which products 190 are to be delivered to the online shopper 110. In the embodiment illustrated in FIG. 1, the electronic notification may be transmitted via the network 125 from the central computing device 150 to electronic devices including but not limited to: computing device at a retail store 160, specialty distribution center 170, and/or regional distribution center 180; electronic device of a worker at any of such facilities; and/or consumer computing device 120).

For example, the central computing device 150 can transmit a signal over the network 125 to a computing device at a specialty distribution center 170 to notify a computing device operator (e.g., manager or worker) at the specialty distribution center 170 that this specialty distribution center 170 has been selected to receive a delivery from a product manufacturer facility 175. Similarly, the central computing device 150 can transmit a signal over the network 125 to a computing device at a regional distribution center 180 to notify a computing device operator (e.g., manager or worker) at the regional distribution center 180 that this regional distribution center 180 has been selected to receive a shipment from a product manufacturer facility 175. Similarly, the central computing device 150 can transmit a signal over the network 125 to a computing device at a retail store 160 to notify a computing device operator (e.g., manager or worker) at the retail store 160 that this retail store 160 has been selected to receive a shipment from a specialty distribution center 170 or a regional distribution center 180. Similarly, the central computing device 150 can transmit a signal over the network 125 to a consumer computing device 120 to notify the online shopper 110 that a delivery to the online shopper 110 has been dispatched from the specialty distribution center 170 or the regional distribution center 180. In some embodiments, the electronic notifications sent by the central computing device 150 over the network 125 include but are not limited to short message service (SMS) messages, electronic mail (e-mail) messages, instant messenger messages, voice mail messages, and/or push notifications. In some embodiments, the control circuit 210 of the central computing device 150 is configured to receive an acknowledgment from an electronic device of the worker and/or a computing device at any of the retail store 160, specialty distribution center 170, and/or regional distribution center 180.

In some embodiments, the control circuit 210 of the central computing device 150 is programmed to obtain inventory management data from the electronic database 140 via the network 125 and, based on the inventory management data obtained from the electronic database 140, analyze the total quantity of products 190 in the product shipment being shipped from the manufacturer facility 175 to the specialty distribution center 170 or regional distribution center 180 in order in order to determine whether the total quantity of products 190 in the product shipment supports the product shipment being routed from the manufacturer facility 175 directly to the specialty distribution center 170, or directly to the regional distribution center 180.

In some embodiments, the control circuit 210 of the central computing device 150 is programmed such that, upon a determination that the quantity of products 190 in the product shipment supports the product shipment being routed from the manufacturer facility 175 directly to the regional distribution center 180, the control circuit 210 transmits a signal from the central computing device 150 over the network 125 to the computing device at the manufacturer facility 175, with the signal including instructions to route the product shipment from the manufacturer facility 175 directly to the regional distribution center 180. For example, in some configurations, the control circuit 210 of the central computing device 150 is programmed to determine that inventory management data supports a product shipment to be routed to the regional distribution center 180 when an analysis of the inventory management data by the control circuit 210 indicates a high (or low) retail store count that is geographically dense (i.e., spaced apart by less than a configurable threshold distance). In one aspect, the control circuit 210 of the central computing device 150 is programmed to determine that inventory management data supports a product shipment to be routed to the regional distribution center 180 when an analysis of the inventory management data by the control circuit 210 indicates that retail store demand is not geographically dense, and that the cost of the pick method (i.e., pick-n-pack vs. case pick) favors case picking, and that the Time Supply of Order Quantity is less than Department Threshold (which is configurable) and Supply Availability is not optimal.

In some embodiments, the control circuit 210 of the central computing device 150 is programmed such that, upon a determination that the quantity of products 190 in the product shipment supports the product shipment being routed from the manufacturer facility 175 directly to the specialty distribution center 170, the control circuit 210 transmits a signal from the central computing device 150 over the network 125 to a computing device at the manufacturer facility 175, with the signal can include instructions to route the product shipment from the manufacturer facility 175 directly to the specialty distribution center 170. For example, in some configurations, the control circuit 210 of the central computing device 150 is programmed to determine that inventory management data supports a product shipment to be routed to the specialty distribution center 170 when an analysis of the inventory management data by the control circuit 210 indicates that a shelf capacity of a retail store 160 is less than the case pack quantity and cost to pick and pack is low (an amount that can be considered low is configurable on a case-by-case basis), and the retail stores 160 are geographically dispersed (i.e., spaced apart by more than a configurable threshold distance), and the demand at the retail store 160 is high (an amount that can be considered high is configurable on a case-by-case basis).

In some embodiments, the control circuit 210 of the central computing device 150 is programmed to analyze, based on the inventory management data obtained from the electronic database 140, a total quantity of products 190 in a product shipment being shipped from the specialty distribution center 170 to the regional distribution center 180, a retail store 160, or an internet customer in order to determine whether the quantity of products 190 in the product shipment supports the product shipment being shipped from the specialty distribution center 170 directly to the regional distribution center 180, directly to the retail store 160, or directly to the internet customer. In one aspect, the control circuit 210 of the central computing device 150 is programmed such that, upon a determination that the quantity of products 190 in the product shipment supports the product shipment being routed from the specialty distribution center 170 directly to the regional distribution center 180, transmit a signal from the central computing device 150 over the network 125 to a computing device of the specialty distribution center 170, with the signal including instructions to route the product shipment from the specialty distribution center 170 directly to the regional distribution center 180. In another aspect, the control circuit 210 of the central computing device 150 is programmed such that, upon a determination that the quantity of products 190 in the product shipment supports the product shipment being routed from the specialty distribution center 170 directly to the retail store 160, transmit a signal from the central computing device 150 over the network 125 to a computing device of the specialty distribution center 170, with the signal including instructions to route the product shipment from the specialty distribution center 170 directly to the retail store 160. In yet another aspect, the control circuit 210 of the central computing device 150 is programmed such that, upon a determination that the quantity of products in the product shipment supports the product shipment being routed from the specialty distribution center 170 directly to the online shopper 110, transmit a signal from the computing device over the network to a computing device of the specialty distribution center 170, with the signal including instructions to route the product shipment from the specialty distribution center 170 directly to the online shopper 110.

In some aspects, the control circuit 210 of the central computing device 150 is programmed to analyze, based on the inventory management data obtained from the electronic database 140, a total quantity of products 190 in a product shipment to be shipped from the regional distribution center 180 to a retail store 160 or an online shopper 110 in order to determine whether the quantity of products 190 in the product shipment supports the product shipment being shipped from the regional distribution center 180 directly to the retail store 160, or directly to the internet customer. In one aspect, the control circuit 210 of the central computing device 150 is programmed such that, upon a determination that the quantity of products 190 in the product shipment supports the product shipment being routed from the regional distribution center 170 directly to the online shopper 110, transmit a signal from the central computing device 150 over the network 125 to a computing device of the regional distribution center 180, with the signal including instructions to route the product shipment from the regional distribution center 180 directly to the retail store 160. In another aspect, the control circuit 210 of the central computing device 150 is programmed such that, upon a determination that the quantity of products 190 in the product shipment supports the product shipment being routed from the regional distribution center 180 directly to the online shopper 110, transmit a signal from the central computing device 150 over the network 125 to a computing device of the regional distribution center 180, the signal including instructions to route the product shipment from the regional distribution center 180 directly to the online shopper 110.

In some embodiments, the control circuit 210 of the central computing device 150 is programmed to analyze factors other than number of products 190 in a shipment. For example, in certain aspects, the control circuit 210 of the central computing device 150 is configured to analyze at least one of the following aforementioned inventory management factors stored in the electronic database 140 in order to determine whether the total quantity of products 190 in the product shipment supports the product shipment being routed from the manufacturer facility 175 directly to the specialty distribution center 170 or directly to the regional distribution center 180, or the product shipment being routed from the specialty distribution center 170 and/or regional distribution center 180 and/or retail store 160 to the online shopper: (1) on-hand inventory at each of the retail stores 160, specialty distribution centers 170, and regional distribution centers 180; (2) storage capacity of shelves of retail store 160; (3) actual customer demand data; (4) replenishment requests and pending orders being fulfilled by the retailer and a total number of the products 190 in transit; (5) a total quantity of products 190 in a product shipment being shipped from a manufacturer facility 175 to a specialty distribution center 170 or regional distribution center 180; (6) cost to pick-n-pack vs. case pick; (7) shipping efficiencies; (8) inbound freight cost; (9) cost per unit of product 190; (10) cost of handling the products 190 at a given specialty distribution center 170 and/or regional distribution center 180; (11), landed cost; (12) carrying cost; (13) reverse logistics; (14) geographic locations of the manufacturer facility 175, retail store 160, specialty distribution center 170, and regional distribution center 180; (15) product supply availability; (16) time supply of order quantity; (17) profit margin per unit of product 190; (18) merchandising hierarchy; (19) thresholds; (20) actual customer demand data; and (21) customer demand forecast data.

As discussed above, in some aspects, the electronic database 140 includes customer demand forecast data associated with the products 190 stocked at the retail stores 160, specialty distribution centers 170, and regional distribution centers 180 of the retailer. In some aspects, such customer demand forecast data is obtained from the electronic database 140 by the central computing device 150 when determining how to allocate the products 190 between the retail stores 160, specialty distribution centers 170, and regional distribution centers 180 based on the customer demand forecast data obtained from the electronic database 140. For example, product allocation determinations by the control circuit 210 of the central computing device 150 can include, but are not limited to: how many units of each product 190 to stock at each retail store 160, specialty distribution center 170, and regional distribution center 180 and how many units of each product 190 are to be shipped (for replenishment purposes) to each retail store 160, specialty distribution center 170, and regional distribution center 180. As such, when the customer demand forecast data obtained from the electronic database 140 indicates a projected large increase in orders by online shoppers 110 for a given product 190 in one week, the central computing device 150 can allocate more units of that product 190 to be shipped to that retail store 160 from the regional distribution center 180 (e.g., in cases, if the forecast demand is below a predetermined threshold) or from the specialty distribution center 180 (e.g., in pallets, if the forecast demand is above a predetermined threshold) to avoid potentially having too little inventory at the retail store 160 when the forecast customer demand comes to fruition.

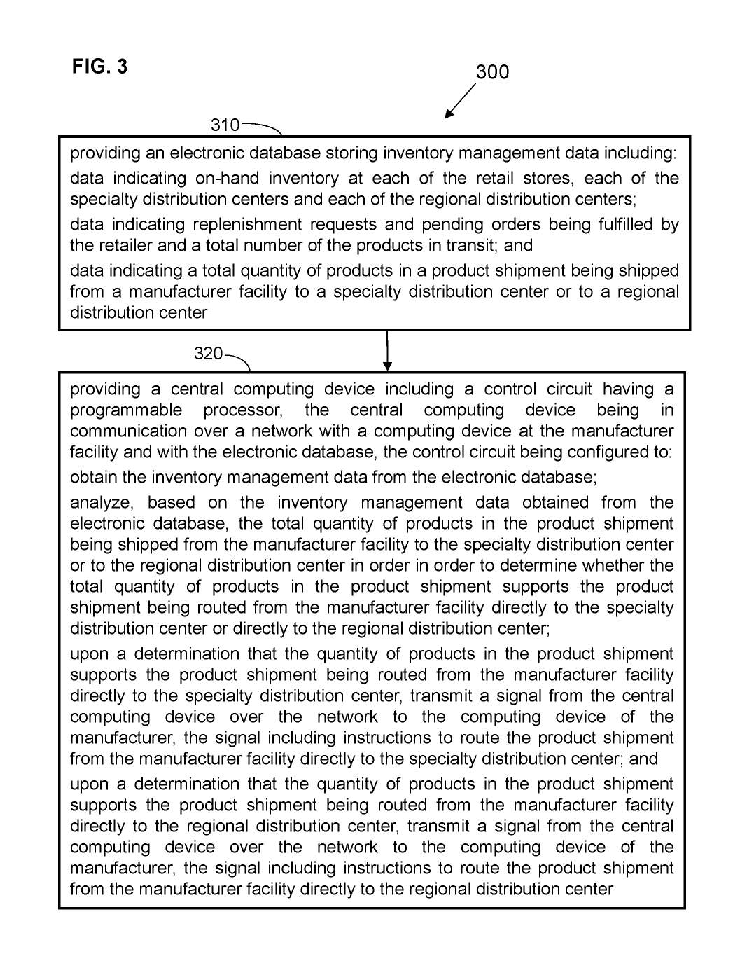

FIG. 3 shows an embodiment of a method 300 of facilitating distribution of products 190 between product manufacturer facilities 175 and retail stores 160 of a retailer via specialty distribution centers 170 and regional distribution centers 180 of the retailer. For exemplary purposes, the method 300 is described in the context of the system of FIG. 1, but it is understood that embodiments of the method 300 may be implemented in system 100 or other systems. Generally, and as discussed above, when products 190 are shipped to a retailer from product supplier or product manufacturer facilities 175, the methods and system described herein provides for an optimal cost-effective and efficient routing of the shipments and allocation of the products 190 between the various facilities of the retailer.

The method 300 of FIG. 3 includes providing an electronic database 140 storing inventory management data (step 310). Generally, the method includes storing in the electronic database 140 data pertaining to the inventory of products 190 stocked at facilities of the retailer, for example, retail store 160, specialty distribution center 170, regional distribution center 180, or the like, and/or products 190 ordered by the retailer and/or products 190 being shipped from manufacturer facilities 175 to such facilities of the retailer. For example, in some aspects, the method 300 includes storing in the electronic database 140 data indicating on-hand inventory at one or more retail stores 160, specialty distribution centers 170, and regional distribution centers 180 of the retailer. The method 300 can include storing in the electronic database 140 at least the 20 inventory management factors described above and which are not reproduced again here.

Generally, after a customer (e.g., online shopper 110) purchases a product 190 from the retailer via the order processing server 130 of the retailer and elects (via the graphical interface 122 of the consumer computing device 120) to have the products 190 ordered by the online shopper 110 delivered to an address designated by the online shopper 110, the method 300 includes providing a central computing device 150 that is in communication over a network 125 with a computing device 175 at the manufacturer facility and with the electronic database 140, and obtaining inventory management data from the electronic database 140 via the central computing device 150 and making a determination based on the obtained inventory management data as to from which facility (e.g., retail store 160, specialty distribution center 170, or regional distribution center 180) to deliver the products 190 to the online shopper (step 320). Similarly, after a retail store generates an order (i.e., replenishment request) and transmits this order to the order processing server 130, the method 300 includes obtaining inventory management data from the electronic database 140 via the central computing device 150 and making a determination based on the obtained inventory management data as to from which facility (e.g., specialty distribution center 170 or regional distribution center 180) to transport such products 190 to the retail store 160. The analysis underlying such determinations has been described above and will not be reproduced here.

In the exemplary method 300 of FIG. 3, after the central computing device 150 obtains the aforementioned inventory management data from the electronic database 140, the central computing device 150 analyzes the inventory management data obtained from the electronic database 140 in order to determine the total quantity of products 190 in the product shipment being shipped from the product manufacturer facility 175 to the specialty distribution center 170 or regional distribution center 180, and determines whether the total quantity of products 190 in the product shipment supports the product shipment being routed from the manufacturer facility 175 directly to the specialty distribution center 170 or regional distribution center 180. After the central computing device 150 determines that the quantity of products 190 in the product shipment supports the product shipment being routed from the manufacturer facility 175 directly to the specialty distribution center 170, the method 300 includes transmitting a signal from the central computing device 150 over the network 125 to a computing device at the manufacturer facility 175, with the signal including instructions to route the product shipment from the manufacturer facility 175 directly to the specialty distribution center 170. As such, if the central computing device 150, based on an analysis of one or more of the aforementioned inventory management data factors obtained from the electronic database 140, determines that it is more economical and/or efficient for the retailer to route the product shipment to the specialty distribution center 170, not the regional distribution center 180, the central computing device 150 notifies the manufacturer facility 175 (or shipping company that transports products 190 from the manufacturer facility 175) to route the product shipment to the specialty distribution center 170.

In one aspect, after the central computing device 150 determines that the quantity of products 190 in the product shipment supports the product shipment being routed from the manufacturer facility 175 directly to the regional distribution center 170, the method 300 includes transmitting a signal from the central computing device 150 over the network 125 to a computing device at the manufacturer facility 175, with the signal including instructions to route the product shipment from the manufacturer facility directly to the regional distribution center 180. Thus, if the central computing device 150, based on an analysis of one or more of the aforementioned inventory management factors obtained from the electronic database 140, determines that it is more economical and/or efficient for the retailer to route the product shipment to the regional distribution center 180, not the specialty distribution center 170, the central computing device 150 notifies the manufacturer facility 175 (or shipping company that transports products 190 from the manufacturer facility 175) to route the product shipment to the regional distribution center 180.

As described above, after the central computing device 150 determines, based on an analysis of the inventory management data obtained from the electronic database 140, that a given product shipment is to be delivered from the manufacturer facility 175 directly to the retail store 160, specialty distribution center 170, or regional distribution center 180, the method 300 includes transmitting from the central computing device 150 and over the network 125, an electronic notification to the manufacturer facility 175, retail store 160, specialty distribution center 170, regional distribution center 180, and/or shipping company in order to indicate the determined route (e.g., destination) of the product shipment. In some aspects, such a notification can be transmitted by the central computing device 150 directly to computing device at the manufacturer facility 175, retail store 160, specialty distribution center 170, regional distribution center 180, and/or a shipping company, or to an electronic device of a worker (e.g., manager drive, or the like) of the manufacturer facility 175, retail store 160, specialty distribution center 170, regional distribution center 180, and/or shipping company.

After such an electronic notification from the central computing device 150 is received by the manufacturer facility 175, retail store 160, specialty distribution center 170, regional distribution center 180, and/or shipping company, the manufacturer facility 175, retail store 160, specialty distribution center 170, regional distribution center 180, and/or shipping company can use a computing device (e.g., a central computer or a hand-held worker device) to transmit a return signal to the central computing device 150 indicating that the products 190 in the product shipment were successfully delivered to the facility indicated in the electronic notification transmitted by the central computing device 150. Then, in some embodiments, the central computing device 150, after receiving this return signal, transmits a signal to the electronic database 140 in order to update the inventory management data in the electronic database 140 such that the successful delivery of the product shipment to a given facility is reflected.

As mentioned above, in some embodiments, based on the inventory management data obtained from the electronic database 140, the control circuit 210 of the central computing device 150 is programmed to perform an analysis that enables the control circuit 210 to arrive at a decision as to which facility (e.g., retail store 160, specialty distribution center 170, or regional distribution center 180) to use as the facility from which to deliver the products 190 to the online shopper. For example, in one aspect, the control circuit 210 is programmed to generate a list of the retail store 160, specialty distribution center 170, or regional distribution center 180 that stock the product 190 that was ordered by the online shopper and that are located within a predetermined radius (e.g., 5 miles, 10 miles, 25 miles, 50 miles, etc.) of the customer-specified delivery address such that the product 190 may be delivered to the customer 110 within the time specified by the customer 110 (e.g., 2 hours, 4 hours, 1 day, 2 days, etc.) when placing the order.

In one embodiment, based on the data obtained from the electronic database 140, the control circuit 210 of the central computing device 150 is programmed to determine a cost (i.e., monetary cost to the retailer) of delivering the product 190 to the customer 110 within the customer-specified time frame from each of the retail stores 160, specialty distribution centers 170, and regional distribution centers 180 on the generated list, then determine a total amount of time required to deliver the product from each of the listed retail stores 160, specialty distribution centers 170, and regional distribution centers 180 to the customer 110. In one aspect, the control circuit 210 of the central computing device 150 is programmed to generate a ranking of each of the retail stores 160, specialty distribution centers 170, and regional distribution centers 180 on the list based on the total cost of delivering the product 190 to the customer 110 from such facilities within the timeframe specified by the customer 110 when placing the internet order. In some aspects, based on the inventory management data obtained from the electronic database 140 and based on the generated delivery cost ranking, the control circuit 210 of the central computing device 150 is programmed to select, from the retail stores 160, specialty distribution centers 170, and regional distribution centers 180 stored in the electronic database 140 (and appearing on the aforementioned generated list of facilities that are capable to deliver the product 190 to the customer 110 within the customer-specified timeframe), a retail store 160, specialty distribution center 170, or regional distribution center 180 associated with the lowest delivery cost as the retail store 160, specialty distribution center 170, or regional distribution center 180 from which to deliver the customer-ordered product 190 to the customer-specified delivery location.

In one exemplary embodiment, during the process flow associated with determining from which retail store 160, specialty distribution center 170, or regional distribution center 180 to deliver the customer-ordered product to the customer 110, the control circuit 210 is programmed to analyze the inventory management data by filtering through the on-hand inventory and geographic locations of the retail stores 160, specialty distribution centers 170, and regional distribution centers 180 in the electronic database 140 in order to determine which of these facilities have the customer-ordered product 190 in stock and are located within a predefined radius (e.g., 5 miles, 10 miles, 25 miles, 50 miles, etc.) considered to be acceptable for delivering the product 190 to the customer 110 within the time frame specified by the customer 110. This on-hand and geographic location-based filter would eliminate retail stores 160, specialty distribution centers 170, and regional distribution centers 180 that do not have the customer-ordered product 190 in stock and that are too far from the customer's designated delivery location to enable delivery of the product 190 to the customer 110 within the time frame specified by the customer 110.

After the control circuit 210 runs the on-hand and geographic location filters to arrive at a list of retail stores 160, specialty distribution centers 170, and regional distribution centers 180 that meet the on-hand and location requirements, the control circuit 210 is further programmed to run a cost analysis in association with each of the remaining retail stores 160, specialty distribution centers 170, and regional distribution centers 180 with respect to the mission of delivering the product 190 ordered by the customer 110 to the customer-specified delivery location within the time frame specified by the customer. In one aspect, the control circuit 210 is programmed to generate a ranking of the remaining retail stores 160, specialty distribution centers 170, and regional distribution centers 180 based on the estimated delivery cost associated with each one of these facilities, and to then select the retail store 160, specialty distribution center 170, or regional distribution center 180 that is ranked highest (i.e., associated with the lowest delivery cost) as the retail store 160, specialty distribution center 170, or regional distribution center 180 from which the product 190 ordered by the customer will be delivered to the customer 110. In some implementations, after the control circuit 210 of the central computing device 150 determines the retail store 160, specialty distribution center 170, or regional distribution center 180 associated with the lowest delivery cost, the control circuit 210 causes the computing device 150 to send an electronic notification to the selected retail store 160, specialty distribution center 170, or regional distribution center 180 in order to notify the selected retail store 160, specialty distribution center 170, or regional distribution center 180 that the product 190 is to be delivered to the customer 110 therefrom within the time frame specified by the customer 110 when placing the order.

After the control circuit 210 runs the on-hand and geographic location filters to arrive at a list of retail stores 160, specialty distribution centers 170, and regional distribution centers 180 that meet the on-hand and location requirements, the control circuit 210 is further programmed to run a cost analysis in association with each of the remaining retail stores 160, specialty distribution centers 170, and regional distribution centers 180 with respect to the mission of delivering the product 190 ordered by the customer 110 to the customer-specified delivery location within the time frame specified by the customer. In one aspect, the control circuit 210 is programmed to generate a ranking of the remaining retail stores 160, specialty distribution centers 170, and regional distribution centers 180 based on the estimated delivery cost associated with each one of these facilities, and to then select the retail store 160, specialty distribution center 170, or regional distribution center 180 that is ranked highest (i.e., associated with the lowest delivery cost) as the retail store 160, specialty distribution center 170, or regional distribution center 180 from which the product 190 ordered by the customer will be delivered to the customer 110. In some implementations, after the control circuit 210 of the central computing device 150 determines the retail store 160, specialty distribution center 170, or regional distribution center 180 associated with the lowest delivery cost, the control circuit 210 causes the computing device 150 to send an electronic notification to the selected retail store 160, specialty distribution center 170, or regional distribution center 180 in order to notify the selected retail store 160, specialty distribution center 170, or regional distribution center 180 that the product 190 is to be delivered to the customer 110 therefrom within the time frame specified by the customer 110 when placing the order.

The systems and methods described herein advantageously enable retailers to fulfil online orders and product replenishment requests by analyzing inventory management data and optimizing product shipments to, and product allocations between, the retailer's product stocking facilities based on such analysis. Accordingly, the systems and methods described herein improve the efficiency of product shipments to and from retailer's facilities by 25-50% compared to conventional systems in that shipments having a sub-optimal quantity and/or are duplicative can be reduced and/or eliminated, and the retailers are enabled to move products received from product manufacturers to their retail facilities mush faster. In addition, the systems and methods described herein improve the cost-effectiveness of product shipments from retailer's facilities to the customer by 25-50% compared to conventional systems in that the facility from which the delivery is to be made is selected based on having the lowest estimated delivery cost as compared to other possible facilities of the retailer from which the product may be delivered to the customer. As such, the present systems and methods result in significant cost savings to the retailers and optimize the retailer's product allocation to assure efficient product replenishment to the retail stores.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

1. A system for facilitating distribution of products between product manufacturers and retail stores of a retailer via specialty distribution centers and regional distribution centers of the retailer, the system comprising:
an electronic database storing inventory management data including:
data indicating on-hand inventory at each of the retail stores, each of the specialty distribution centers and each of the regional distribution centers;
data indicating replenishment requests and pending orders being fulfilled by the retailer and a total number of the products in transit; and
data indicating a total quantity of products in a product shipment being shipped from a manufacturer facility to a specialty distribution center or to a regional distribution center;
a central computing device including a control circuit having a programmable processor, the central computing device being in communication over a network with a computing device at the manufacturer facility and with the electronic database; and
an order processing server configured to process an order for at least one product placed by an internet customer, the order processing server being configured to transmit over the network, a product fulfillment request to the central computing device based on the order processed by the order processing server
wherein the control circuit is configured to:
receive product replenishment requests over the network from a computing device of the retail store, from a computing device of the specialty distribution center, and from the computing device of the computing device of the regional distribution center;
after receipt of the product fulfillment request from the order processing server, to obtain the inventory management data from the electronic database and analyze the inventory management data obtained from the electronic database in order to determine whether the at least one product ordered by the customer is to be delivered to the customer from the specialty distribution center, regional distribution center, or retail store;
based on the inventory management data obtained from the electronic database define a total quantity of products to be shipped from the manufacturer facility to the specialty distribution center or the regional distribution center, from the specialty distribution center to the regional distribution center or a retail store, and from the regional distribution center to the retail store;
obtain the inventory management data from the electronic database;
analyze, based on the inventory management data obtained from the electronic database, the total quantity of products in the product shipment being shipped from the manufacturer facility to the specialty distribution center or to the regional distribution center in order in order to determine whether the total quantity of products in the product shipment supports the product shipment being routed from the manufacturer facility directly to the specialty distribution center or directly to the regional distribution center;
upon a determination that the quantity of products in the product shipment supports the product shipment being routed from the manufacturer facility directly to the specialty distribution center, transmit a signal from the central computing device over the network to the computing device of the manufacturer, the signal including instructions to route the product shipment from the manufacturer facility directly to the specialty distribution center; and
upon a determination that the quantity of products in the product shipment supports the product shipment being routed from the manufacturer facility directly to the regional distribution center, transmit a signal from the central computing device over the network to the computing device of the manufacturer, the signal including instructions to route the product shipment from the manufacturer facility directly to the regional distribution center.

2. The system of claim 1, wherein the specialty distribution center is larger in size than the regional distribution center and is adapted to receive the products from the manufacturer facility only on pallets and to unpack the products from the pallets, and wherein the regional distribution center is smaller in size than the specialty distribution center and is adapted to receive the products from the manufacturer facility or the specialty distribution center on pallets, in cases, or as eaches.

3. The system of claim 1, wherein the control circuit is further configured to:
analyze, based on the inventory management data obtained from the electronic database, a total quantity of products in a product shipment being shipped from the specialty distribution center to the regional distribution center, a retail store, or an internet customer in order to determine whether the quantity of products in the product shipment supports the product shipment being shipped from the specialty distribution center directly to the regional distribution center, directly to the retail store, or directly to the internet customer;
upon a determination that the quantity of products in the product shipment supports the product shipment being routed from the specialty distribution center directly to the regional distribution center, transmit a signal from the central computing device over the network to a computing device of the specialty distribution center, the signal including instructions to route the product shipment from the specialty distribution center directly to the regional distribution center;
upon a determination that the quantity of products in the product shipment supports the product shipment being routed from the specialty distribution center directly to the retail store, transmit a signal from the central computing device over the network to a computing device of the specialty distribution center, the signal including instructions to route the product shipment from the specialty distribution center directly to the retail store; and
upon a determination that the quantity of products in the product shipment supports the product shipment being routed from the specialty distribution center directly to the internet customer, transmit a signal from the computing device over the network to a computing device of the specialty distribution center, the signal including instructions to route the product shipment from the specialty distribution center directly to the internet customer.

4. The system of claim 1, wherein the control circuit is further configured to:
analyze, based on the inventory management data obtained from the electronic database, a total quantity of products in a product shipment to be shipped from the regional distribution center to a retail store or an internet customer in order to determine whether the quantity of products in the product shipment supports the product shipment being shipped from the regional distribution center directly to the retail store, or directly to the internet customer;
upon a determination that the quantity of products in the product shipment supports the product shipment being routed from the regional distribution center directly to the retail store, transmit a signal from the central computing device over the network to a computing device of the regional distribution center, the signal including instructions to route the product shipment from the regional distribution center directly to the retail store; and
upon a determination that the quantity of products in the product shipment supports the product shipment being routed from the regional distribution center directly to the internet customer, transmit a signal from the central computing device over the network to a computing device of the regional distribution center, the signal including instructions to route the product shipment from the regional distribution center directly to the internet customer.

5-7. (canceled)

8. The system of claim 1, wherein the electronic database further comprises customer demand forecast data associated with the products stocked at the retail store, the products stocked at the regional distribution center, and the products stocked at the specialty distribution center.

9. The system of claim 8, control circuit of the central computing device is configured to obtain the customer demand forecast data from the electronic database and to allocate, based on the customer demand forecast data obtained from the electronic database, stocking of the products in the product shipment from the manufacturer facility between the specialty distribution center, the regional distribution center, and the retail store.

10. The system of claim 1, wherein the control circuit of the central computing device is configured to analyze at least one of the following additional factors in order to determine whether the total quantity of products in the product shipment supports the product shipment being routed from the manufacturer facility directly to the specialty distribution center or directly to the regional distribution center: shipping efficiencies, freight factor, cost of goods sold, cost of handling the products at the specialty distribution center, cost of handling the products at the regional distribution center, landed cost, carrying costs, and geographic locations of the manufacturer facility, the specialty distribution center, and the regional distribution center.

11. A method for facilitating distribution of products between product manufacturers and retail stores of a retailer via specialty distribution centers and regional distribution centers of the retailer, the method comprising:
providing an electronic database storing inventory management data including:
data indicating on-hand inventory at each of the retail stores, each of the specialty distribution centers and each of the regional distribution centers;
data indicating replenishment requests and pending orders being fulfilled by the retailer and a total number of the products in transit; and
data indicating a total quantity of products in a product shipment being shipped from a manufacturer facility to a specialty distribution center or to a regional distribution center;
providing a central computing device including a control circuit having a programmable processor, the central computing device being in communication over a network with a computing device at the manufacturer facility and with the electronic database; and
providing an order processing server configured to process an order for at least one product placed by an internet customer,
transmitting via the order processing server and over the network, a product fulfillment request to the central computing device based on the order processed by the order processing server;
obtaining, via the central computing device, the inventory management data from the electronic database;
analyzing, via the control circuit of the central computing device, the inventory management data obtained from the electronic database in order to determine whether the at least one product ordered by the customer is to be delivered to the customer from the specialty distribution center, regional distribution center, or retail store;
receiving, via the central computing device, product replenishment requests over the network from a computing device of the retail store, from a computing, device of the specialty distribution center, and from the computing device of the computing device of the regional distribution center:
defining, via the control circuit of the central computing device and based on the inventory management data obtained from the electronic database, a total quantity of products to be shipped from the manufacturer facility to the specialty distribution center or the regional distribution center, from the specialty distribution center to the regional distribution center or a retail store, and from the regional distribution center to the retail store;
analyzing, via the control circuit of the central computing device, based on the inventory management data obtained from the electronic database, the total quantity of products in the product shipment being shipped from the manufacturer facility to the specialty distribution center or to the regional distribution center in order in order to determine whether the total quantity of products in the product shipment supports the product shipment being routed from the manufacturer facility directly to the specialty distribution center or directly to the regional distribution center;
upon a determination by the control circuit of the central computing device that the quantity of products in the product shipment supports the product shipment being routed from the manufacturer facility directly to the specialty distribution center, transmitting a signal from the central computing device over the network to the computing device of the manufacturer, the signal including instructions to route the product shipment from the manufacturer facility directly to the specialty distribution center; and
upon a determination by the control circuit of the central computing device that the quantity of products in the product shipment supports the product shipment being routed from the manufacturer facility directly to the regional distribution center, transmitting a signal from the central computing device over the network to the computing device of the manufacturer, the signal including instructions to route the product shipment from the manufacturer facility directly to the regional distribution center.

12. The method of claim 11, wherein the specialty distribution center is larger in size than the regional distribution center and is adapted to receive the products from the manufacturer facility only on pallets and to unpack the products from the pallets, and wherein the regional distribution center is smaller in size than the specialty distribution center and is adapted to receive the products from the manufacturer facility or the specialty distribution center on pallets, in cases, or as caches.

13. The method of claim 11, further comprising:
analyzing, via the control circuit and based on the inventory management data obtained from the electronic database, a total quantity of products in a product shipment being shipped from the specialty distribution center to the regional distribution center, a retail store, or an internet customer in order to determine whether the quantity of products in the product shipment supports the product shipment being shipped from the specialty distribution center directly to the regional distribution center, directly to the retail store, or directly to the internet customer;
transmitting, upon a determination that the quantity of products in the product shipment supports the product shipment being routed from the specialty distribution center directly to the regional distribution center, a signal from the central computing device over the network to a computing device of the specialty distribution center, the signal including instructions to route the product shipment from the specialty distribution center directly to the regional distribution center;
transmitting, upon a determination that the quantity of products in the product shipment supports the product shipment being routed from the specialty distribution center directly to the retail store, a signal from the central computing device over the network to a computing device of the specialty distribution center, the signal including instructions to route the product shipment from the specialty distribution center directly to the retail store; and
transmitting, upon a determination that the quantity of products in the product shipment supports the product shipment being routed from the specialty distribution center directly to the internet customer, a signal from the computing device over the network to a computing device of the specialty distribution center, the signal including instructions to route the product shipment from the specialty distribution center directly to the internet customer.

14. The method of claim 11, further comprising:
analyzing, based on the inventory management data obtained from the electronic database, a total quantity of products in a product shipment to be shipped from the regional distribution center to a retail store or an internet customer in order to determine whether the quantity of products in the product shipment supports the product shipment being shipped from the regional distribution center directly to the retail store, or directly to the internet customer;
transmitting, upon a determination that the quantity of products in the product shipment supports the product shipment being routed from the regional distribution center directly to the retail store, a signal from the central computing device over the network to a computing device of the regional distribution center, the signal including instructions to route the product shipment from the regional distribution center directly to the retail store; and
transmitting, upon a determination that the quantity of products in the product shipment supports the product shipment being routed from the regional distribution center directly to the internet customer, a signal from the central computing device over the network to a computing device of the regional distribution center, the signal including instructions to route the product shipment from the regional distribution center directly to the internet customer.

15-17. (canceled)

18. The method of claim 11, further comprising storing on the electronic database customer demand forecast data associated with the products stocked at the retail store, the products stocked at the regional distribution center, and the products stocked at the specialty distribution center.

19. The method of claim 18, further comprising:
obtaining, via the control circuit of the central computing device, the customer demand forecast data from the electronic database; and
allocating, based on the customer demand forecast data obtained from the electronic database, stocking of the products in the product shipment from the manufacturer facility between the specialty distribution center, the regional distribution center, and the retail store.

20. The method of claim 11, further comprising analyzing, via the control circuit of the central computing device, at least one of the following additional factors in order to determine whether the total quantity of products in the product shipment supports the product shipment being routed from the manufacturer facility directly to the specialty distribution center or directly to the regional distribution center: shipping efficiencies, freight factor, cost of goods sold, cost of handling the products at the specialty distribution center, cost of handling the products at the regional distribution center, landed cost, carrying costs, and geographic locations of the manufacturer facility, the specialty distribution center, and the regional distribution center.
